(19) United States
(12) Patent Application Publication
(10) Pub. No.: US 2022/0082620 A1
(43) Pub. Date: Mar. 17, 2022

(54) SECURE AND CONFIGURABLE TEST INTERACE FOR AN INTELLECTUAL PROPERTY (IP) BLOCK IN A SYSTEM ON A CHIP (SOC)

(71) Applicant: Intel Corporation, Santa Clara, CA (US)

(72) Inventors: Balajiraja Ravinarayanan, Lucan (IE); Allyn Hunt, Naas (IE); Gordon Walsh, Naas (IE); Mark Hogan, Drogheda (IE); Michael Morgan, Naas (IE); Ruben Trejo Calle, Dublin 15 (IE); Alfonso Tarazona Martinez, Naas (IE); Shravan Kumar Hossur Gopala Rao, Naas (IE)

(73) Assignee: Intel Corporation, Santa Clara, CA (US)

(21) Appl. No.: 17/537,015

(22) Filed: Nov. 29, 2021

(51) Int. Cl. G01R 31/317; G01R 31/3183; G01R 31/3185; G06F 30/333

(52) U.S. Cl. CPC G01R 31/31724; G06F 30/333; G01R 31/318555; G01R 31/318314

(57) ABSTRACT

A design for test (DFT) block of a system on a chip (SOC) includes a function mapping interface coupled to a set of function interfaces of an intellectual property (IP) block core; and a core coupled to the function mapping interface by a plurality of test interfaces, the core including an interposer to manage assignments of the plurality of test interfaces from the function mapping interface to a plurality of placeholder interfaces of a collar, wherein the function mapping interface maps the set of function interfaces to the plurality of test interfaces.

### FIELD OF THE DISCLOSURE

This disclosure relates generally to an intellectual property (IP) block in a system on a chip (SOC) in a computing system, and more particularly, to a secure and configurable test interface for an IP block in a SOC in a computing system.

### BACKGROUND

When delivering IP blocks to a SOC design team for integration, IP block design teams need to consider how test logic is inserted into the IP block and how the IP block may be kept safe from a security and privacy perspective. When designing an IP block where instances of functions (such as memory) are distributed, perhaps through several layers of a hierarchy, and often traversing through third-party IP blocks, traditional electronic design automation (EDA) tools and flows don't fully support insertion of built-in self-test (BIST) functionality. Most EDA tools offer flows where the EDA tool reads and edits the register transfer language (RTL) design of the IP block to achieve a flat insertion of the functions, however, this may not be possible, for example, if there are functions (such as memories) in nested very high-speed integrated circuit (VHIC) hardware design language (VHDL) blocks. The flat insertion process also requires exposing the IP block to the SOC integration team, which is not always desirable, especially when an external company is licensing the IP block for integration into the external company's SOC. Adding to this complexity, IP blocks may be manufactured on multiple internal and external process technology nodes.

### BRIEF DESCRIPTION OF THE DRAWINGS

FIG. 1 is a diagram of a SOC according to some embodiments.

FIG. 2 is a diagram of a SOC according to other embodiments.

FIGS. 3A and 3B are flow diagrams of test interface processing according to some embodiments.

FIG. 4 is a block diagram of an example processor platform structured to execute and/or instantiate the machine-readable instructions and/or operations of FIGS. 3A and 3B to implement the apparatus discussed with reference to FIGS. 1-2.

FIG. 5 is a block diagram of an example implementation of the processor circuitry of FIG. 4.

FIG. 6 is a block diagram of another example implementation of the processor circuitry of FIG. 4.

FIG. 7 is a block diagram illustrating an example software distribution platform to distribute software such as the machine-readable instructions and/or operations of FIG. 3 to hardware devices owned and/or operated by third parties.

The figures are not to scale. In general, the same reference numbers will be used throughout the drawing(s) and accompanying written description to refer to the same or like parts.

### DETAILED DESCRIPTION

Implementations of the technology described herein provide a system and method for providing a secure and configurable test interface for use in designing intellectual property (IP) blocks and SOCs. In an embodiment, interfaces (as defined, for example, by SystemVerilog, Institute of Electrical and Electronics Engineers (IEEE) standard 1800, or other suitable standards), mod ports, and interposer circuitry is used to insert built-in self-test (BIST) functionality into a distributed function (such as a memory) design of an IP block of a SOC. Embodiments work with encrypted RTL delivery flows and without the need to rely on EDA tools modifying RTL design files for the IP block. Embodiments decrease complexities of handling product design changes, physical layout changes or manufacturing technology process node changes.

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and/or other changes may be made without departing from the scope of the subject matter of this disclosure. The following detailed description is, therefore, provided to describe example implementations and not to be taken as limiting on the scope of the subject matter described in this disclosure. Certain features from different aspects of the following description may be combined to form yet new aspects of the subject matter discussed below.

As used herein, connection references (e.g., attached, coupled, connected, and joined) may include intermediate members between the elements referenced by the connection reference and/or relative movement between those elements unless otherwise indicated. As such, connection references do not necessarily infer two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real-world imperfections.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

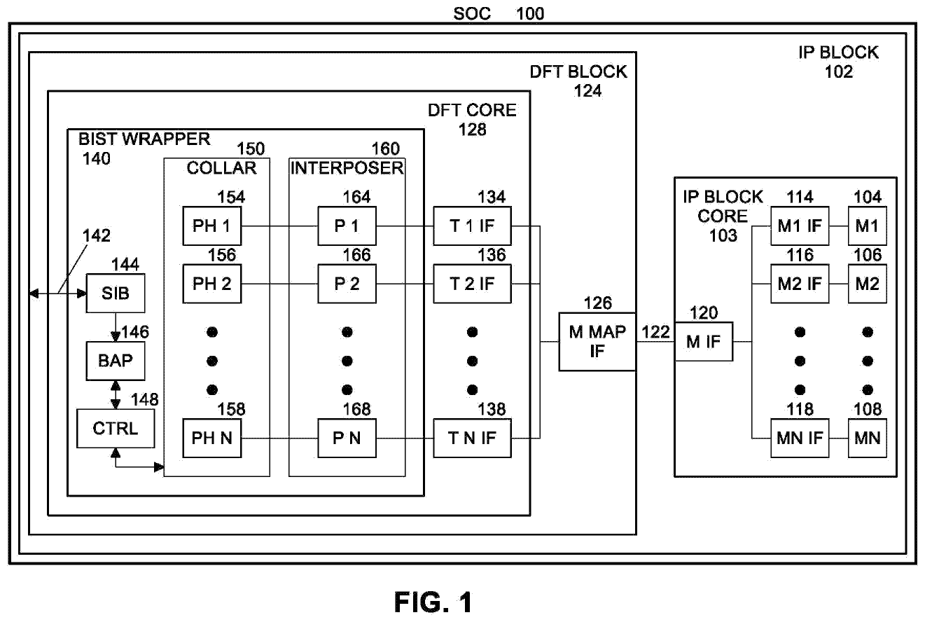

FIG. 1 is a diagram of a SOC 100 according to some embodiments. In an embodiment, SOC 100 an integrated circuit (IC) (also known as a “chip”) that integrates one or more components of a computer system or other electronic system. These components may include one or more processors (e.g., central processing units (CPUs), etc.), memory, input/output (I/O) ports and secondary storage, radio modems, and a graphics processing unit (GPU)—all on a single substrate or microchip. SOC 100 may contain digital, analog, mixed-signal or radio frequency signal processing functions. SOC 100 includes at least one IP block 102 to implement one or more of the above components. IP block 102 includes at least one IP block core 103 and design for test (DFT) block 124. In an embodiment, IP block core 103 includes a plurality of functions, denoted herein as M1 104, M2 106, . . . MN 108, where n is a natural number. A function may comprise any useful processing hardware. For example, the plurality of functions 104, 106, . . . 108 may comprise a plurality of memories. In an embodiment, a function may comprise a plurality of smaller functions. For example, when the function is a memory, the memory may comprise a plurality of smaller memories. In an embodiment, the memories are distributed across a plurality of layers of a hierarchy of functions within IP block core 103. In other examples, the functions may comprise phased locked loops (PLLs), power circuits, fuses, temperature sensors, voltage monitors, etc. In an embodiment, the design of the IP block may be modular, containing two or more levels of nested, physical partitions, the number of partitions being dependent on a given SOC product configuration. In an embodiment, SOC 100 includes a plurality of IP blocks, wherein at least one of the functions is located in an IP block that is provided by a third party and the design information of this third-party block is inaccessible to the designer of the SOC.

Access to each function in IP block core 103 is obtained through a corresponding function interface (IF). Thus, function interface M1 IF 114 provides access to function M1 104, function interface M2 IF 116 provides access to function M2 106, . . . function interface MN IF 118 provides access to function MN 108. In an embodiment, the interface for a function includes one or more control signal lines. For example, M1 IF 114 may be a one-dimensional array of interfaces, with the dimension relating to a number of physical modules in M1 104. The physical modules comprising a function may be changed to gain additional physical levels and/or timing performance. The dimension and size of the array may change with differences in products and/or manufacturing processes. In an embodiment, where a function M is a memory, the interface for the memory includes one or more memory control signal lines, such as signal lines to read the memory, write the memory, and control the memory (e.g., set the memory in a low power sleep state or bring the memory back from a low power sleep state). Set of function interfaces M IF 120 comprises an array of function interfaces (M1 IF 114, M2 116, . . . MN 118). In some embodiments, the number of dimensions of the array of function interfaces is more than one (e.g., two, three, four, etc.). In an embodiment, set of function interfaces M IF 120 is a two-dimensional array of interfaces, where the second dimension relates to a number of function instances generated in the configuration of the IP block core 103. The dimension and size of the array may change with differences in products and/or manufacturing processes.

In some embodiments, design information (e.g., VHDL) for IP block 102 is encrypted prior to distribution of the IP block to a customer who is to integrate the IP block into an SOC. This deters unauthorized access to the IP block.

Accessing the functions in IP block core 103 of SOC 100 may be desirable during a design validation and/or testing phase after the SOC is manufactured. IP block core 103 provides a function interface M IF 120 to allow an entity external to the IP block to access the control signal lines of the functions. In an embodiment where there are N functions (e.g., memories), the N function interfaces M1 IF 114, M2 IF 116, . . . MN IF 118 are coupled to set of function interfaces M IF 120. Set of function interfaces M IF 120 provides a physical interface 122 on SOC 100 for accessing functions of IP block core 103.

In an embodiment, DFT block 124 of IP block 102 may be used to test IP block core 103 after manufacture of SOC 100. DFT block 124 includes at least one DFT core 128. DFT core 128 includes built-in self-test (BIST) wrapper 140. DFT block 124 provides an interface 142 to access IP block core 103. In an embodiment, this interface 142 is a Joint Test Action Group (JTAG) debug and test interface which is coupled to a segment insertion bit (SIB) 144 within BIST wrapper 140. SIB 144 is coupled to BIST access port (BAP) 146, which is coupled in turn to controller (CTRL) 148. Controller 148 can read and/or write one or more of a plurality of placeholder interfaces PH 1 154, PH 2 156, . . . PH N 158 within collar 150, where N is a natural number. As used herein, collar 150 refers to circuitry encompassing the placeholder interfaces. Each placeholder interface includes one or more control signal lines. In an embodiment, the one or more control signal lines of each placeholder interface are mapped to a corresponding one or more control signal lines of a function interface in IP block 102 (e.g., one of M1 IF 114, M2 IF 116, . . . MN IF 118). In an embodiment, SIB 144, BAP 146, CTRL 148, and collar 150 are generated by an EDA tool.

BIST wrapper 140 includes interposer 160 to manage assignments of test interfaces to placeholder interfaces. Interposer 160 may respectively couple the plurality of placeholder interfaces PH 1 154, PH 2 156, . . . PH N 158 to a plurality of test interfaces T 1 IF 134, T 2 IF 136, . . . T N IF 138, where N is a natural number. Interposer 160 includes mod port P 1 164, mod port P 2 166, . . . mod port P N 168, wherein mod port P 1 164 couples placeholder interface PH 1 154 to test interface T 1 IF 134, mod port P 2 166 couples placeholder interface PH 2 156 to test interface T 2 IF 136, . . . mod port P N 168 couples placeholder interface PH N 158 to test interface T N IF 138. In an embodiment, interposer 160 is generated based at least in part on the SOC product configuration and the manufacturing process node on which the SOC and/or IP block will be manufactured. DFT block 124 includes function mapping interface 126 (M MAP IF) to map placeholder interfaces PH 1 154, PH 2 156, . . . PH N 158 in DFT core 128 to function interfaces M 1 IF 114, M2 IF 116, . . . MN IF 118 in IP block core 103. In an embodiment, function mapping interface 126 flattens two-dimensional arrays of interfaces into one-dimensional arrays of interfaces. In an embodiment, function mapping interface 126 groups all physical function (e.g., memory) instances for a given function (e.g., memory) together.

In an embodiment, for each function (M1 104, M2 106, . . . MN 108) of IP block core 103, control signal lines (such as BIST, repair, and power isolation signals) are bundled into a SystemVerilog interface (e.g., the set of function interfaces M IF 120 comprising function interfaces M1 IF 114, M2 IF 116, . . . MN IF 118) and routed to BIST wrapper 140 (co-located on SOC 100). These function interfaces (e.g., M1 IF 114, M2 IF 116, . . . MN IF 118) are bundled into one-dimensional or two-dimensional arrays of interfaces (e.g., set of function interfaces M IF 120) and routed to the co-located BIST wrapper 140 using function mapping interface 126 and the test interfaces. In BIST wrapper 140, the interfaces are flattened into one-dimensional arrays of interfaces (e.g., PH 1 154, PH 2 156, . . . PH N 158) which can be accessed via JTAG 142 for external mode insertion of BIST functionality. Interface flattening is achieved by use of function mapping interface 126 (M MAP IF), which creates a 1:1 mapping/assignment from each function (e.g., memory) to a BIST placeholder interface. Interface assignments are made by interposer 160, where each function control signal line is assigned to a corresponding control signal line in a corresponding placeholder interface.

Depending on the physical layout conditions and process node selection, each function (e.g., M1 104, M2 106, . . . MN 108) can be assembled from multiple physical modules (also referred to as a memory cut or physical cut). For example, when M1 104 is a memory module, M1 may be split into four physical memory modules. Each physical memory module requires its own corresponding placeholder module (e.g., PH 1 154). In this example, interface M1 IF 114 would be constructed of an array of four interfaces, with each interface connecting to the relevant physical control signals of function M1 104. As functions (M1 104, M2 106, . . . MN 108) are instantiated in a generate loop, the array size of this loop determines the array size of the two-dimensional array comprising set of interfaces M IF 120. Function connections (such as memory connections) are transmitted through the IP Block 102 design as two-dimensional arrays of interfaces; this avoids the need to port punch each individual function signal through the design. Flattening of this two-dimensional array of interfaces M IF 120 is achieved by use of function mapping interface M MAP IF 126. M MAP IF 126 flattens the two-dimensional array of interfaces related to the generate loop used in instantiating the memory functions (M1 104, M2 106, . . . MN 108). Interposer 160 further flattens each one-dimensional array of interfaces (T1 IF 134, T2 IF 136, . . . , T N IF 138), so as to create a 1:1 connection with placeholder PH N and the physical function (e.g., memory) cut denoted by MN 108.

As used herein, the interfaces are defined in a parameterized manner, where parameters control the number of physical cuts, address, data, and size parameters, as well as the number of interfaces grouped into a two-dimensional array of interfaces. This has the added benefit of containing any memory changes to a single file.

In an embodiment, a definition of interposer 160 is generated by executing, on a processor of a computer system, a Python script developed to create needed Verilog design files, BIST configuration files, and a set of connectivity checker tests. In an embodiment, the create interposer script takes an RTL elaborated log file as an input parameter and outputs design information for interposer 160. The elaborated log file may be derived from an encrypted RTL database. If an IP block provider does not want to provide the means to create a simulated elaborated log file (e.g., to further secure the design of the IP block), the create interposer script may also refer to a Javascript object notation (JSON) formatted metadata file including information describing the memory modules, their size, address width and location in the IP block (e.g., hierarchical path). In various embodiments, there are other ways to generate the details of the create interposer script.

The create interposer script reads one or more simulated and elaborated RTL log files and builds a plurality of JSON formatted metadata files, for each function (e.g., memory). Whenever a function change is made for a given partition, the interposer 160, memory mapping interface 126, interface definitions and parameter file can be recreated from this simulated elaborated log file. Any change in functions may require generation of a new BIST wrapper 140 design and a new interposer 160 for SOC integration. The script may identify arrays of functions, arrays of SystemVerilog interfaces, and correctly bundle individual function interfaces into these arrays. The script may also pair individual functions with their correct external BIST placeholder interfaces, on a 1:1 relationship.

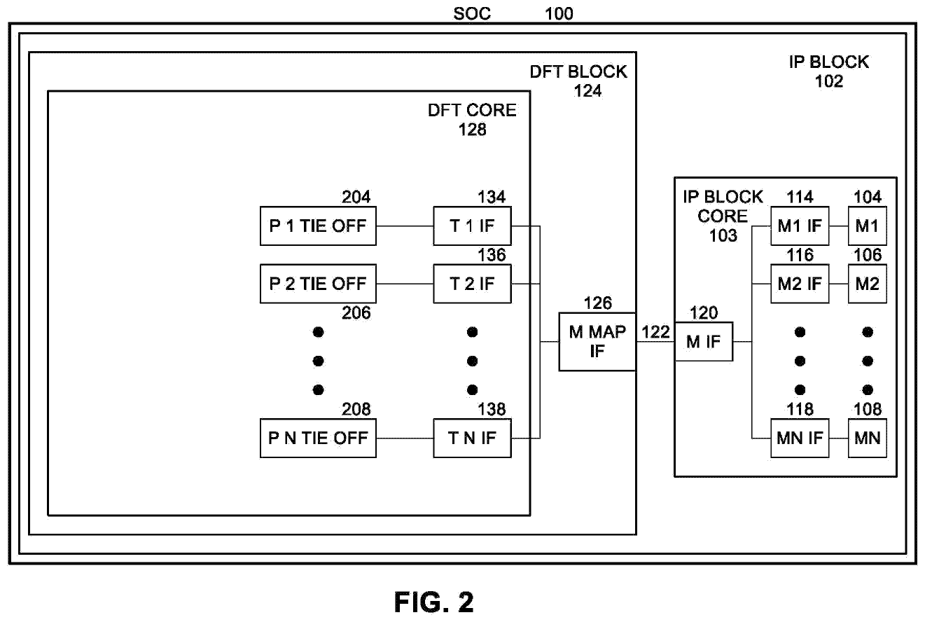

Embodiments allow an IP block design team to generate design information for a SOC integration team to complete BIST insertion without needing to read or modify RTL design files for IP block core 103. In instances where the SOC integration team is conducting test logic insertion and physical, design or validation work in parallel, a dummy DFT block 124 can also be provided to allow the SOC integration team to continue that work while test logic insertion is being completed. FIG. 2 is a diagram of a SOC according to other embodiments. In this embodiment, DFT core 128 in DFT block 124 is modified to “tie off” the connection for each test interface. Thus, test interface T 1 IF 134 is coupled to P 1 tie off 204, T 2 IF 136 is coupled to P 2 tie off 206, . . . T N IF 138 is coupled to P N tie off 208. Each port of a given interface (e.g., T 1 IF) can be tied to a safe value, such as ground or logic one. This will allow an RTL compiler to correctly synthesize the IP block design, allowing other functional design teams (RTL, physical, validation, etc.) to continue to work in parallel.

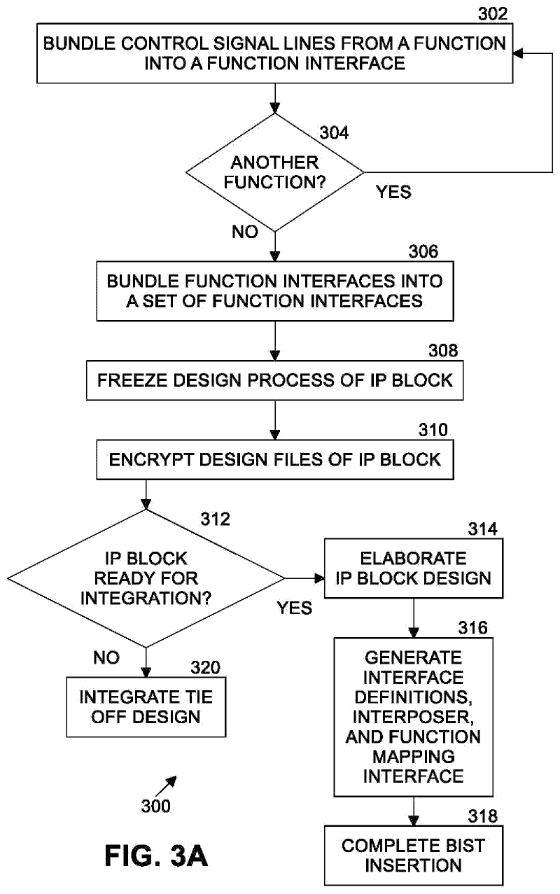

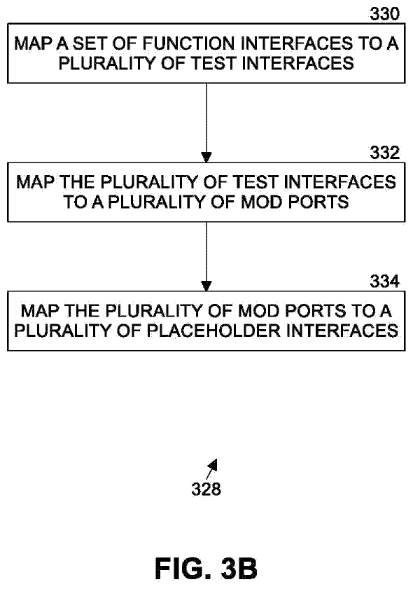

FIG. 3A is a flow diagram of test interface processing 300 according to some embodiments. At block 302, control signal lines from a function in the IP block core 103 design (as defined by RTL) are bundled into a function interface. For example, control signal lines from function M1 104 are bundled into function interface M1 IF 114. In an embodiment, the function interface is a SystemVerilog interface. At block 304, if another function of the IP block core is to be processed, processing continues back at block 302 with the next function of the IP block core. At block 304, if all functions of the IP block core have been processed, then processing continues with block 306. At block 306, the one or more function interfaces determined at block 302 are bundled into a set of function interfaces. For example, function interfaces M1 IF 114, M2 IF 116, . . . MN IF 118 are bundled into set of function interfaces M IF 120. In an embodiment, the set of function interfaces is a two-dimensional array of function interfaces. The set of function interfaces M IF 120 is routed through the design of the BIST wrapper 140. Function interfaces may be tied to a safe value in BIST wrapper 140.

At block 308, the design process of the IP block is frozen. At block 310, the design files defining the IP block are encrypted to deter unauthorized access. In an embodiment, blocks 302-310 are performed during a design process for the IP block (e.g., for customization of the IP block for a particular SOC). The IP block design files may then be distributed to a SOC integration team.

In an embodiment, blocks 312-320 are performed during a SOC design and/or integration process where the SOC integrates the IP block design. At block 312, when the IP block is ready for integration into a SOC, at block 314 the IP block design is elaborated. In an embodiment, elaboration includes simulating the IP block design in the SOC using an EDA tool, resulting in an elaborated simulated log file. At block 316, interface definitions for the functions, interposer 160 and function mapping interface M MAP IF 126 are generated. In an embodiment, the elaborated simulated log file is parsed (via automated processes) to create a file for the definition of the interposer 160 and a file for the definition of the function mapping interface 126. These files (e.g., comprising a script) can optionally be delivered to IP block customers (e.g., SOC integrators) to allow the IP block customers to regenerate the interposer and the function mapping interface design files to account for any additional required function changes. At block 318, the IP block customer integrates the design files for the interposer and the function mapping interface into the SOC and completes BIST insertion. BIST insertion comprises circuitry, added by a SOC integration team, to conduct functional BIST testing (e.g., memory BIST testing) using SIB 144, BAP 146, controller 148, collar 150, and JTAG interface 142.

The technology described herein allows an IP block design team to create a full suite of design files required to achieve BIST insertion into an IP block core, without the need to send unencrypted RTL design information of the IP block core to SOC integration teams. Since a full design solution can be delivered, the SOC integration teams do not need to rely on EDA tools reading in the RTL design of the IP block and editing RTL files to route function control signal lines (e.g., memory control signal lines) through each level of a hierarchy of the IP block core (as done in a prior art flat insertion processing mode and an existing port punching approach). Embodiments do not require use of a given EDA tool and work with any EDA tools offering an external BIST flow. Embodiments are robust to RTL changes arising from process node changes, memory module changes, or memory control port changes. Function (e.g., memory) RTL changes may be confined to a single file. Process specific mod port definitions and macros may also be defined and separated into their own specific files. Another advantage is that there is no requirement for functions (such as memories) to be co-located and BIST wrapper 140, containing interposer 160, may be moved in the SOC design (perhaps closer to function instantiations), to give better physical performance for the SOC. Embodiments allow for scaling across multiple process nodes, by confining all process node specific changes to a single file. Performance of prior art flat insertion is prone to introducing bugs to the RTL codebase and requires additional validation, in the form of formal equivalence checks. Embodiments described herein reduce the potential for introducing such functionality breaking bugs. Formal equivalence checks can be performed on a reduced scope of the design, as fewer design files are modified.

FIG. 3B is a flow diagram of test interface processing 328 according to an embodiment. At block 330, function mapping interface M MAP IF 126 of DFT block 124 maps a set of function interfaces M IF 120 to a plurality of test interfaces T 1 IF 134, T 2 IF 136, . . . T N IF 138. At block 332, interposer 160 of DFT core 128 of DFT block 124 maps the plurality of test interfaces to a plurality of mod ports P 1 164, P 2 166, . . . P N 168. At block 334, interposer 160 maps the plurality of mod ports to a plurality of placeholder interfaces PH 1 154, PH 2 156, . . . PH N 158.

While an example manner of implementing the SOC 100 of FIG. 1 is illustrated in FIGS. 1-3, one or more of the elements, processes, and/or devices illustrated in FIGS. 1-3 may be combined, divided, re-arranged, omitted, eliminated, and/or implemented in any other way. Further, the example SOC circuitry may be implemented by hardware, software, firmware, and/or any combination of hardware, software, and/or firmware. Thus, for example, any of the example SOC circuitry could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example SOC circuitry is/are hereby expressly defined to include a non-transitory computer readable storage device or storage disk such as a memory, a digital versatile disk (DVD), a compact disk (CD), a Blu-ray disk, etc., including the software and/or firmware. Further still, the example circuitry of FIG. 1 may include one or more elements, processes, and/or devices in addition to, or instead of, those illustrated in FIG. 1, and/or may include more than one of any or all of the illustrated elements, processes and devices.

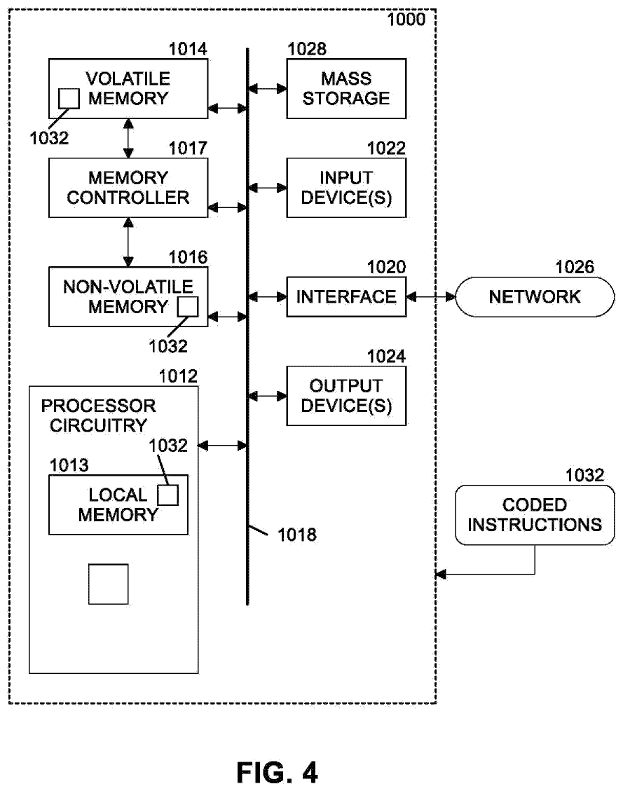

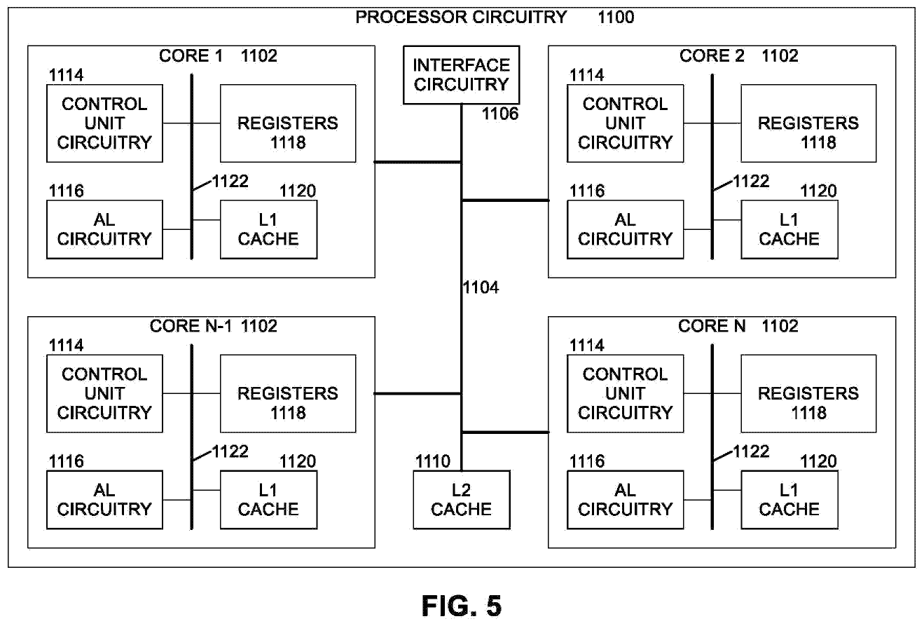

Flowcharts representative of example hardware logic circuitry, machine readable instructions, hardware implemented state machines, and/or any combination thereof for implementing the SOC 100 of FIGS. 1-2 are shown in FIGS. 3A and 3B. The machine readable instructions may be one or more executable programs or portion(s) of an executable program for execution by processor circuitry, such as the processor circuitry 812 shown in the example processor platform 800 discussed below in connection with FIG. 4 and/or the example processor circuitry discussed below in connection with FIGS. 5 and/or 6. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 3A and 3B, many other methods of implementing the example SOC 100 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable media, as used herein, may include machine readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3A and 3B may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a block diagram of an example processor platform 1000 structured to execute and/or instantiate the machine-readable instructions and/or operations of FIGS. 3A and 3B to implement the apparatus of FIGS. 1-2. The processor platform 1000 can be, for example, a SOC, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1000 of the illustrated example includes processor circuitry 1012. The processor circuitry 1012 of the illustrated example is hardware. For example, the processor circuitry 1012 can be implemented by one or more integrated circuits, logic circuits, FPGAs microprocessors, CPUs, GPUs, DSPs, and/or microcontrollers from any desired family or manufacturer. The processor circuitry 1012 may be implemented by one or more semiconductor based (e.g., silicon based) devices.

The processor circuitry 1012 of the illustrated example includes a local memory 1013 (e.g., a cache, registers, etc.). The processor circuitry 1012 of the illustrated example is in communication with a main memory including a volatile memory 1014 and a non-volatile memory 1016 by a bus 1018. The volatile memory 1014 may be implemented by Synchronous Dynamic Random-Access Memory (SDRAM), Dynamic Random-Access Memory (DRAM), RAMBUS® Dynamic Random-Access Memory (RDRAM®), and/or any other type of RAM device. The non-volatile memory 1016 may be implemented by flash memory and/or any other desired type of memory device. Access to the volatile memory 1014 and/or non-volatile 1016 of the illustrated example is controlled by a memory controller 1017.

The processor platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1022 are connected to the interface circuitry 1020. The input device(s) 1022 permit(s) a user to enter data and/or commands into the processor circuitry 1012. The input device(s) 1022 can be implemented by, for example, an audio sensor, a microphone, a camera (still or video), a keyboard, a button, a mouse, a touchscreen, a trackpad, a trackball, an iso-point device, and/or a voice recognition system.

One or more output devices 1024 are also connected to the interface circuitry 1020 of the illustrated example. The output devices 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1000 of the illustrated example also includes one or more mass storage devices 1028 to store software and/or data. Examples of such mass storage devices 10210 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine-readable instructions 1032, which may be implemented by the machine-readable instructions of FIG. 3, may be stored in the mass storage device 1028, in the volatile memory 1014, in the non-volatile memory 1016, and/or on a removable non-transitory computer readable storage medium such as a CD or DVD.

FIG. 5 is a block diagram of an example implementation of the processor circuitry 1012 of FIG. 4. In this example, the processor circuitry 1012 of FIG. 4 is implemented by processor circuitry 1100 (e.g., a microprocessor). For example, the processor circuitry 1100 may implement multi-core hardware circuitry such as a CPU, a DSP, a GPU, an XPU, etc. Although it may include any number of example cores 1102 (e.g., 1 core), the processor circuitry 1100 of this example is a multi-core semiconductor device including N cores. The cores 1102 of the processor circuitry 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine-readable instructions and/or operations represented by the flowcharts of FIGS. 3A and 3B.

The cores 1102 may communicate by an example bus 1104. In some examples, the bus 1104 may implement a communication bus to effectuate communication associated with one(s) of the cores 1102. For example, the bus 1104 may implement at least one of an Inter-Integrated Circuit (I2C) bus, a Serial Peripheral Interface (SPI) bus, a PCI bus, or a PCIe bus. Additionally or alternatively, the bus 1104 may implement any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory (e.g., Level 1 (L1) cache 1120 that may be split into an L1 data cache and an L1 instruction cache), the processor circuitry 1100 also includes example shared memory 1110 that may be shared by the cores (e.g., Level 2 (L2_cache)) for high-speed access to data and/or instructions. Data and/or instructions may be transferred (e.g., shared) by writing to and/or reading from the shared memory 1110. The local memory of each of the cores 1102 and the shared memory 1110 may be part of a hierarchy of storage devices including multiple levels of cache memory and the main memory (e.g., the main memory 1014, 1016 of FIG. 4). Typically, higher levels of memory in the hierarchy exhibit lower access time and have smaller storage capacity than lower levels of memory. Changes in the various levels of the cache hierarchy are managed (e.g., coordinated) by a cache coherency policy.

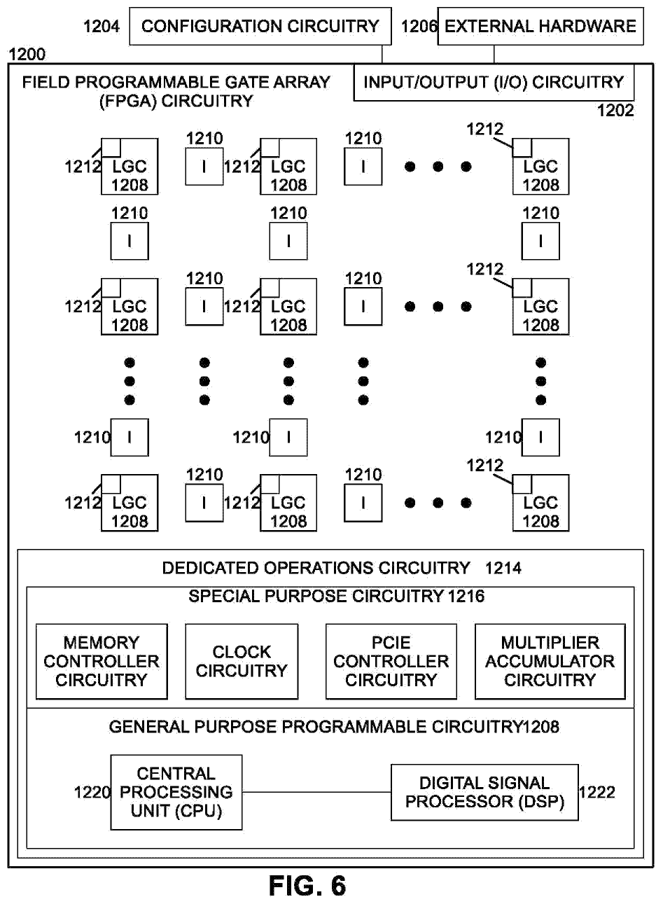

One or more of the cores 1102 may be referred to as a CPU, DSP, GPU, etc., or any other type of hardware circuitry. Cores 1102 include control unit circuitry 1114, arithmetic and logic (AL) circuitry (sometimes referred to as an ALU) 1116, a plurality of registers 1118, the L1 cache 1120, and an example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer-based operations. In other examples, the AL circuitry 1116 also performs floating point operations. In yet other examples, the AL circuitry 1116 may include first AL circuitry that performs integer-based operations and second AL circuitry that performs floating point operations. In some examples, the AL circuitry 1116 may be referred to as an Arithmetic Logic Unit (ALU). The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 6. Alternatively, the registers 1118 may be organized in any other arrangement, format, or structure including distributed throughout the core 1102 to shorten access time. The bus 1122 may implement at least one of an I2C bus, a SPI bus, a PCI bus, or a PCIe bus.

Cores 1102 and/or, more generally, the processor circuitry 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The processor circuitry 1100 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general-purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 6 is a block diagram of another example implementation of the processor circuitry 1012 of FIG. 4. In this example, the processor circuitry 1012 is implemented by FPGA circuitry 1200. The FPGA circuitry 1200 can be used, for example, to perform operations that could otherwise be performed by the example processor circuitry 1100 of FIG. 5 executing corresponding machine-readable instructions. However, once configured, the FPGA circuitry 1200 instantiates the machine-readable instructions in hardware and, thus, can often execute the operations faster than they could be performed by a general-purpose microprocessor executing the corresponding software.

More specifically, in contrast to the processor circuitry 1100 of FIG. 5 described above (which is a general purpose device that may be programmed to execute some or all of the machine readable instructions represented by the flowcharts of FIGS. 3A and 3B but whose interconnections and logic circuitry are fixed once fabricated), the FPGA circuitry 1200 of the example of FIG. 6 includes interconnections and logic circuitry that may be configured and/or interconnected in different ways after fabrication to instantiate, for example, some or all of the machine readable instructions represented by the flowcharts of FIGS. 3A and 3B. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the software represented by the flowcharts of FIGS. 3A and 3B. As such, the FPGA circuitry 1200 may be structured to effectively instantiate some or all of the machine-readable instructions of the flowcharts of FIGS. 3A and 3B as dedicated logic circuits to perform the operations corresponding to those software instructions in a dedicated manner analogous to an ASIC. Therefore, the FPGA circuitry 1200 may perform the operations corresponding to the some or all of the machine-readable instructions of FIGS. 3A and 3B faster than the general-purpose microprocessor can execute the same.

In the example of FIG. 6, the FPGA circuitry 1200 is structured to be programmed (and/or reprogrammed one or more times) by an end user by a hardware description language (HDL) such as Verilog. The FPGA circuitry 1200 of FIG. 6, includes example input/output (I/O) circuitry 1202 to obtain and/or output data to/from example configuration circuitry 1204 and/or external hardware (e.g., external hardware circuitry) 1206. For example, the configuration circuitry 1204 may implement interface circuitry that may obtain machine readable instructions to configure the FPGA circuitry 1200, or portion(s) thereof. In some such examples, the configuration circuitry 1204 may obtain the machine-readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1206 may implement the processor circuitry 1100 of FIG. 5. The FPGA circuitry 1200 also includes an array of example logic gate circuitry 1208, a plurality of example configurable interconnections 1210, and example storage circuitry 1212. The logic gate circuitry 1208 and interconnections 1210 are configurable to instantiate one or more operations that may correspond to at least some of the machine-readable instructions of FIGS. 3A and 3B and/or other desired operations. The logic gate circuitry 1208 shown in FIG. 6 is fabricated in groups or blocks. Each block includes semiconductor-based electrical structures that may be configured into logic circuits. In some examples, the electrical structures include logic gates (e.g., AND gates, OR gates, NOR gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations. The logic gate circuitry 1208 may include other electrical structures such as look-up tables (LUTs), registers (e.g., flip-flops or latches), multiplexers, etc.

The interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitryl208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 6 also includes example Dedicated Operations Circuitry 1214. In this example, the Dedicated Operations Circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 5 and 6 illustrate two example implementations of the processor circuitry 1012 of FIG. 4, many other approaches are contemplated. For example, as mentioned above, modern FPGA circuitry may include an on-board CPU, such as one or more of the example CPU 1220 of FIG. 6. Therefore, the processor circuitry 1012 of FIG. 4 may additionally be implemented by combining the example processor circuitry 1100 of FIG. 4 and the example FPGA circuitry 1200 of FIG. 6. In some such hybrid examples, a first portion of the machine-readable instructions represented by the flowcharts of FIGS. 3A and 3B may be executed by one or more of the cores 1102 of FIG. 5 and a second portion of the machine-readable instructions represented by the flowcharts of FIGS. 3A and 3B may be executed by the FPGA circuitry 1200 of FIG. 6.

In some examples, the processor circuitry 1012 of FIG. 4 may be in one or more packages. For example, the processor circuitry 1100 of FIG. 5 and/or the FPGA circuitry 1200 of FIG. 6 may be in one or more packages. In some examples, an XPU may be implemented by the processor circuitry 1012 of FIG. 4, which may be in one or more packages. For example, the XPU may include a CPU in one package, a DSP in another package, a GPU in yet another package, and an FPGA in still yet another package.

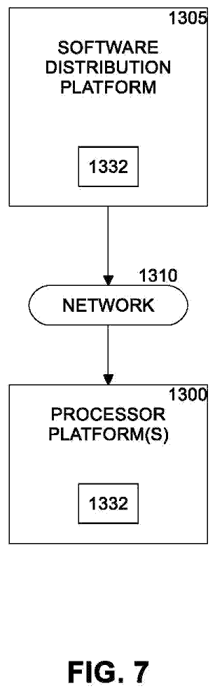

A block diagram illustrating an example software distribution platform 1305 to distribute software such as the example machine-readable instructions 1032 of FIG. 4 to hardware devices owned and/or operated by third parties is illustrated in FIG. 7. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine-readable instructions 1032 of FIG. 4. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine-readable instructions 1032, which may correspond to the example machine readable instructions of FIGS. 3A and 3B, as described above. The one or more servers of the example software distribution platform 1305 are in communication with a network 1310, which may correspond to any one or more of the Internet and/or any of the example networks, etc., described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1032 from the software distribution platform 1305. For example, the software, which may correspond to the example machine readable instructions of FIGS. 3A and 3B, may be downloaded to the example processor platform 1000, which is to execute the machine-readable instructions 1032 to implement the methods of FIGS. 3A and 3B and associated SOC 100. In some examples, one or more servers of the software distribution platform 1305 periodically offer, transmit, and/or force updates to the software (e.g., the example machine-readable instructions 1032 of FIG. 4) to ensure improvements, patches, updates, etc., are distributed and applied to the software at the end user devices.

In some examples, an apparatus includes means for processing an operating state of an endpoint device circuitry based on operating data of the endpoint device circuitry to evaluate suitability of the endpoint device circuitry for an update. For example, the means for processing may be implemented by processor circuitry, processor circuitry, firmware circuitry, etc. In some examples, the processor circuitry may be implemented by machine executable instructions such as that implemented by at least blocks of FIGS. 3A and 3B executed by processor circuitry, which may be implemented by the example processor circuitry 1012 of FIG. 4, the example processor circuitry 1100 of FIG. 5, and/or the example Field Programmable Gate Array (FPGA) circuitry 1200 of FIG. 6. In other examples, the processor circuitry is implemented by other hardware logic circuitry, hardware implemented state machines, and/or any other combination of hardware, software, and/or firmware. For example, the processor circuitry may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, an apparatus includes means for storing a context of the endpoint device circuitry when the endpoint device circuitry is not suitable for the update. For example, the means for storing may be implemented by memory circuitry, etc. In some examples, the memory circuitry may be implemented by machine executable instructions such as that implemented by at least blocks of FIGS. 3A and 3B executed by processor circuitry, which may be implemented by the example processor circuitry 1012 of FIG. 4, the example processor circuitry 1100 of FIG. 5, and/or the example Field Programmable Gate Array (FPGA) circuitry 1200 of FIG. 6, executing in conjunction with memory 1014 and 1016. In other examples, the memory circuitry is implemented by other hardware logic circuitry, hardware implemented state machines, and/or any other combination of hardware, software, and/or firmware. For example, the memory circuitry may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, an apparatus includes means for installing updates to circuitry when the circuitry is suitable for the update. For example, the means for installing may be implemented by processor circuitry, firmware circuitry, etc. In some examples, the processor circuitry and/or firmware circuitry may be implemented by machine executable instructions such as that implemented by at least blocks of FIGS. 3A and 3B executed by processor circuitry, which may be implemented by the example processor circuitry 1012 of FIG. 4, the example processor circuitry 1100 of FIG. 5, and/or the example Field Programmable Gate Array (FPGA) circuitry 1200 of FIG. 6. In other examples, the processor circuitry and/or the firmware circuitry is implemented by other hardware logic circuitry, hardware implemented state machines, and/or any other combination of hardware, software, and/or firmware. For example, the processor circuitry and/or the firmware circuitry may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

From the foregoing, it will be appreciated that example systems, methods, apparatus, and articles of manufacture have been disclosed to improve BIST insertions in IP blocks. The disclosed systems, methods, apparatus, and articles of manufacture improve the efficiency of using a computing device by increasing protection of IP block designs. The disclosed systems, methods, apparatus, and articles of manufacture are accordingly directed to one or more improvement(s) in the operation of a machine such as a computer or other electronic and/or mechanical device.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the examples of this patent.

Example 1 is an apparatus comprising a function mapping interface coupled to a set of function interfaces of an intellectual property (IP) block core; and a core coupled to the function mapping interface by a plurality of test interfaces, the core including an interposer to manage assignments of the plurality of test interfaces from the function mapping interface to a plurality of placeholder interfaces of a collar; wherein the function mapping interface maps the set of function interfaces to the plurality of test interfaces.

In Example 2, the subject matter of Example 1 can optionally include wherein the set of function interfaces comprise a plurality of function interfaces, a function interface of the plurality of function interfaces comprising one or more control signal lines to access a function of the IP block core.

In Example 3, the subject matter of Example 2 can optionally include wherein the function is a memory, and the one or more control signal lines comprise at least one control signal line to read the memory and at least one control signal line to write the memory.

In Example 4, the subject matter of Example 2 can optionally include wherein the set of function interfaces comprise a two-dimensional array of the plurality of function interfaces.

In Example 5, the subject matter of Example 2 can optionally include wherein a test interface of the plurality of test interfaces of the core comprises one or more control signal lines to access the function of the IP block core via the function interface.

In Example 6, the subject matter of Example 5 can optionally include wherein the interposer comprises a plurality of mod ports to couple the plurality of test interfaces to the plurality of placeholder interfaces.

In Example 7, the subject matter of Example 6 can optionally include wherein a mod port of the plurality of mod ports comprises one or more control signal lines to access the one or more control signal lines of the test interface of the core.

In Example 8, the subject matter of Example 7 can optionally include wherein a placeholder interface of the plurality of placeholder interfaces comprises one or more control signal lines to access the mod port of the interposer.

In Example 9, the subject matter of Example 8 can optionally include wherein the core comprises a built-in self-test (BIST) wrapper, the BIST wrapper including the collar and the interposer.

In Example 10, the subject matter of Example 9 can optionally include wherein the BIST wrapper comprises a segment insertion bit (SIB) coupled to a BIST access port (BAP) coupled to a controller coupled to the plurality of placeholder interfaces of the collar.

In Example 11, the subject matter of Example 10 can optionally include the interposer and the function mapping interface to map the function interface to the test interface to the mod port to the placeholder interface.

In Example 12, the subject matter of Example 1 can optionally include wherein the core assigns the plurality of test interfaces to a safe value to “tie off” connections for the plurality of test interfaces.

Example 13 is an apparatus comprising a plurality of intellectual property (IP) blocks; wherein at least one of the IP blocks comprises a function mapping interface coupled to a set of function interfaces of an IP block core; and a core coupled to the function mapping interface by a plurality of test interfaces, the core including an interposer to manage assignments of the plurality of test interfaces from the function mapping interface to a plurality of placeholder interfaces of a collar; wherein the function mapping interface maps the set of function interfaces to the plurality of test interfaces.

In Example 14, the subject matter of Example 13 can optionally include wherein the set of function interfaces comprise a plurality of function interfaces, a function interface of the plurality of function interfaces comprising one or more control signal lines to access a function of the IP block core.

In Example 15, the subject matter of Example 13 can optionally include wherein the interposer comprises a plurality of mod ports to couple the plurality of test interfaces to the plurality of placeholder interfaces.

Example 16 is a method comprising mapping a set of function interfaces of an intellectual property (IP) block core of an IP block of a system on a chip (SOC) to a plurality of test interfaces; mapping the plurality of test interfaces to a plurality of mod ports; and mapping the plurality of mod ports to a plurality of placeholder interfaces; wherein the set of function interfaces comprises a plurality of function interfaces, a function interface of the plurality of function interfaces comprising one or more control signal lines to access a function of the IP block core.

In Example 17, the subject matter of Example 16 can optionally include wherein the function is a memory, and the one or more control signal lines comprise at least one control signal line to read the memory and at least one control signal line to write the memory.

In Example 18, the subject matter of Example 16 can optionally include wherein the set of function interfaces comprise a two-dimensional array of the plurality of function interfaces.

In Example 19, the subject matter of Example 16 can optionally include wherein a test interface of the plurality of test interfaces comprises one or more control signal lines to access the function of the IP block core via the function interface.

In Example 20, the subject matter of Example 19 can optionally include wherein a mod port of the plurality of mod ports comprises one or more control signal lines to access the one or more control signal lines of the test interface.

In Example 21, the subject matter of Example 20 can optionally include wherein a placeholder interface of the plurality of placeholder interfaces comprises one or more control signal lines to access the mod port.

Example 22 is at least one non-transitory machine-readable storage medium comprising instructions that, when executed, cause at least one processing device to at least map a set of function interfaces of an intellectual property (IP) block core of an IP block of a system on a chip (SOC) to a plurality of test interfaces; map the plurality of test interfaces to a plurality of mod ports; and map the plurality of mod ports to a plurality of placeholder interfaces; wherein the set of function interfaces comprises a plurality of function interfaces, a function interface of the plurality of function interfaces comprising one or more control signal lines to access a function of the IP block core.

In Example 23, the subject matter of Example 22 can optionally include wherein the function is a memory, and the one or more control signal lines comprise at least one control signal line to read the memory and at least one control signal line to write the memory.

In Example 24, the subject matter of Example 23 can optionally include wherein the set of function interfaces comprise a two-dimensional array of the plurality of function interfaces.

In Example 25, the subject matter of Example 22 can optionally include wherein a test interface of the plurality of test interfaces comprises one or more control signal lines to access the function of the IP block core via the function interface.

Example 26 is an apparatus comprising means for mapping a set of function interfaces of an intellectual property (IP) block core of an IP block of a system on a chip (SOC) to a plurality of test interfaces; means for mapping the plurality of test interfaces to a plurality of mod ports; and means for mapping the plurality of mod ports to a plurality of placeholder interfaces; wherein the set of function interfaces comprises a plurality of function interfaces, a function interface of the plurality of function interfaces comprising one or more control signal lines to access a function of the IP block core.

What is claimed is:

1. An apparatus comprising:
a function mapping interface coupled to a set of function interfaces of an intellectual property (IP) block core; and
a core coupled to the function mapping interface by a plurality of test interfaces, the core including an interposer to manage assignments of the plurality of test interfaces from the function mapping interface to a plurality of placeholder interfaces of a collar;
wherein the function mapping interface maps the set of function interfaces to the plurality of test interfaces.

2. The apparatus of claim 1, wherein the set of function interfaces comprise a plurality of function interfaces, a function interface of the plurality of function interfaces comprising one or more control signal lines to access a function of the IP block core.

3. The apparatus of claim 2, wherein the function is a memory, and the one or more control signal lines comprise at least one control signal line to read the memory and at least one control signal line to write the memory.

4. The apparatus of claim 2, wherein the set of function interfaces comprise a two-dimensional array of the plurality of function interfaces.

5. The apparatus of claim 2, wherein a test interface of the plurality of test interfaces of the core comprises one or more control signal lines to access the function of the IP block core via the function interface.

6. The apparatus of claim 5, wherein the interposer comprises a plurality of mod ports to couple the plurality of test interfaces to the plurality of placeholder interfaces.

7. The apparatus of claim 6, wherein a mod port of the plurality of mod ports comprises one or more control signal lines to access the one or more control signal lines of the test interface of the core.

8. The apparatus of claim 7, wherein a placeholder interface of the plurality of placeholder interfaces comprises one or more control signal lines to access the mod port of the interposer.

9. The apparatus of claim 8, wherein the core comprises a built-in self-test (BIST) wrapper, the BIST wrapper including the collar and the interposer.

10. The apparatus of claim 9, wherein the BIST wrapper comprises a segment insertion bit (SIB) coupled to a BIST access port (BAP) coupled to a controller coupled to the plurality of placeholder interfaces of the collar.

11. The apparatus of claim 10, the interposer and the function mapping interface to map the function interface to the test interface to the mod port to the placeholder interface.

12. The apparatus of claim 1, wherein the core assigns the plurality of test interfaces to a safe value to “tie off” connections for the plurality of test interfaces.

13. An apparatus comprising:
a plurality of intellectual property (IP) blocks;
wherein at least one of the IP blocks comprises:
a function mapping interface coupled to a set of function interfaces of an IP block core; and
a core coupled to the function mapping interface by a plurality of test interfaces, the core including an interposer to manage assignments of the plurality of test interfaces from the function mapping interface to a plurality of placeholder interfaces of a collar;
wherein the function mapping interface maps the set of function interfaces to the plurality of test interfaces.

14. The apparatus of claim 13, wherein the set of function interfaces comprise a plurality of function interfaces, a function interface of the plurality of function interfaces comprising one or more control signal lines to access a function of the IP block core.

15. The apparatus of claim 13, wherein the interposer comprises a plurality of mod ports to couple the plurality of test interfaces to the plurality of placeholder interfaces.

16. A method comprising:
mapping a set of function interfaces of an intellectual property (IP) block core of an IP block of a system on a chip (SOC) to a plurality of test interfaces;
mapping the plurality of test interfaces to a plurality of mod ports; and
mapping the plurality of mod ports to a plurality of placeholder interfaces;
wherein the set of function interfaces comprises a plurality of function interfaces, a function interface of the plurality of function interfaces comprising one or more control signal lines to access a function of the IP block core.

17. The method of claim 16, wherein the function is a memory, and the one or more control signal lines comprise at least one control signal line to read the memory and at least one control signal line to write the memory.

18. The method of claim 16, wherein the set of function interfaces comprise a two-dimensional array of the plurality of function interfaces.

19. The method of claim 16, wherein a test interface of the plurality of test interfaces comprises one or more control signal lines to access the function of the IP block core via the function interface.

20. The method of claim 19, wherein a mod port of the plurality of mod ports comprises one or more control signal lines to access the one or more control signal lines of the test interface.

21. The method of claim 20, wherein a placeholder interface of the plurality of placeholder interfaces comprises one or more control signal lines to access the mod port.

22. At least one non-transitory machine-readable storage medium comprising instructions that, when executed, cause at least one processing device to at least:
map a set of function interfaces of an intellectual property (IP) block core of an IP block of a system on a chip (SOC) to a plurality of test interfaces;
map the plurality of test interfaces to a plurality of mod ports; and
map the plurality of mod ports to a plurality of placeholder interfaces;
wherein the set of function interfaces comprises a plurality of function interfaces, a function interface of the plurality of function interfaces comprising one or more control signal lines to access a function of the IP block core.

23. The at least one non-transitory machine-readable storage medium of claim 22, wherein the function is a memory, and the one or more control signal lines comprise at least one control signal line to read the memory and at least one control signal line to write the memory.

24. The at least one non-transitory machine-readable storage medium of claim 22, wherein the set of function interfaces comprise a two-dimensional array of the plurality of function interfaces.

25. The at least one non-transitory machine-readable storage medium of claim 22, wherein a test interface of the plurality of test interfaces comprises one or more control signal lines to access the function of the IP block core via the function interface.
